(19) United States
(12) Patent Application Publication
(10) Pub. No.: US 2012/0098501 A1
(43) Pub. Date: Apr. 26, 2012

(54) EFFICIENT LEAD ACID BATTERY CHARGING

(75) Inventor: Anil Paryani, Cerritos, CA (US)

(73) Assignee: Tesla Motors, Inc., Palo Alto, CA (US)

(21) Appl. No.: 12/912,682

(22) Filed: Oct. 26, 2010

(51) Int. Cl. H02J 7/04

(52) U.S. Cl. 320/156; 320/162; 320/161; 180/65.29

(57) ABSTRACT

An apparatus and method for improving use efficiencies of lead-acid batteries, and more particularly to 12V external lead-acid batteries used in vehicles of all types, load-leveling installations, and backup power applications. A method includes the steps of: a) determining a state of charge (SOC) for a lead-acid battery; b) comparing the SOC against a predetermined charge zone, the charge zone having an upper bound no more than about 90% maximum charge and more preferably no more than about 85% maximum charge and the charge zone having a lower bound no less than about 70% maximum charge and more preferably no less than about 75% maximum charge; and c) maintaining a charge of the lead-acid battery wherein the SOC is within the charge zone.

### BACKGROUND OF THE INVENTION

The present invention relates generally to improvements in use efficiencies of lead-acid batteries and more particularly to 12V external lead-acid batteries used in vehicles of all types, load-leveling installations, and backup power applications.

The use of lead-acid batteries is well-known for many different applications. There are different ways of categorizing batteries, such as a rating for the type of application. Batteries may be rated either as deep-cycle or shallow-cycle batteries. A deep-cycle battery will have depth of discharge greater than 50%, and may go as high as 80%.

The present invention primarily concerns itself with charging efficiency of shallow-cycle batteries. Particularly applicable to shallow-cycle batteries having a charging efficiency less than 50% when a state of charge (SOC) of the battery is greater than about 85%. Charging efficiency is very important in these cases because conventional systems are designed so that the batteries normally operate at SOC above 80%, with deeper discharge only occurring during periods of extended high current use. In such systems, the low charge efficiency at high SOC results higher costs and ultimately more carbon emissions.

Most modern EVs use a DC to DC converter to provide energy for the 12 auxiliary system, including charging the 12V battery (which is commonly lead-acid chemistry). The DC to DC converter is an electronic power supply that takes high voltage DC power from the car's traction battery pack, and provides an isolated 12 volt output to power standard accessories. These converters are small, light, silent, and have no moving parts. The DC to DC converter is usually set to provide a solid 14 volt output so lights and accessories work the same as they would in a “normal” car that uses an alternator to charge its battery.

Whenever discussing charging and discharging of a lead-acid battery, due consideration of the possible impact of sulfation must be made. Lead-acid batteries lose energy capacity under continuous partial (i.e., <100% SOC) state of charge operation due to a crystallization of lead sulfate (generically referred to herein as sulfation). This is a well-known and understood process.

What is needed is an apparatus and method for improving use efficiencies of lead-acid batteries and more particularly to 12V external lead-acid batteries used in vehicles of all types, load-leveling installations, and backup power applications without suffering risks of sulfation which reduces cycle life.

### BRIEF SUMMARY OF THE INVENTION

Disclosed is an apparatus and method for improving use efficiencies of lead-acid batteries, and more particularly to 12V external lead-acid batteries used in vehicles of all types, load-leveling installations, and backup power applications without suffering risks of sulfation. A method includes the steps of: a) determining a state of charge (SOC) for a lead-acid battery; b) comparing the SOC against a predetermined charge zone, the charge zone having an upper bound no more than about 90% maximum charge and more preferably no more than about 85% maximum charge and the charge zone having a lower bound no less than about 70% maximum charge and more preferably no less than about 75% maximum charge; and c) maintaining a charge of the lead-acid battery wherein the SOC is within the charge zone.

An apparatus includes an SOC-determiner establishing an SOC for a lead-acid battery, the determiner producing an SOC signal indicating the SOC; a charger, coupled to the lead-acid battery and responsive to the SOC signal, to maintain the SOC for the lead-acid battery within a predetermined charge zone, the predetermined charge zone having an upper bound no more than about 90% maximum charge and more preferably no more than about 85% maximum charge and the charge zone having a lower bound no less than about 70% maximum charge and more preferably no less than about 75% maximum charge.

A system includes a motor powered at least in part by energy provided from an internal combustion of a fuel with an oxidizer that applies a direct force to a mechanical component; an auxiliary load operable at least in part by energy provided at a DC voltage; an alternator, coupled to the mechanical component, for converting a portion of the direct force to the DC voltage; and a lead-acid battery, coupled to the auxiliary load and to the alternator, storing energy at the DC voltage; wherein the alternator determines a SOC for the lead-acid battery and charges the lead-acid battery to maintain the SOC within a predetermined charge zone, the predetermined charge zone including an upper bound no more than about 90% maximum charge and more preferably no more than about 85% maximum charge and the charge zone having a lower bound no less than about 70% maximum charge and more preferably no less than about 75% maximum charge.

A system includes an electric power storage system operating at a first DC voltage; a motor, coupled to the electric power storage system, powered at least in part by energy provided from the storage system at the first DC voltage; an auxiliary load operable at least in part by energy provided at a second DC voltage; a DC/DC converter, coupled to the electric power storage system, for converting the first DC voltage to the second DC voltage; and a lead-acid battery, coupled to the auxiliary load and to the DC/DC converter, storing energy at the second DC voltage; wherein the DC/DC converter determines a SOC for the lead-acid battery and charges the lead-acid battery to maintain the SOC within a predetermined charge zone, the predetermined charge zone including an upper bound no more than about 90% maximum charge and more preferably no more than about 85% maximum charge and the charge zone having a lower bound no less than about 70% maximum charge and more preferably no less than about 75% maximum charge.

A system includes an AC power source powered at least in part by energy provided from an electrical grid; an auxiliary load operable at least in part by energy provided at a DC voltage; a converter, coupled to the AC power source, for converting a portion of the AC power to the DC voltage; and a lead-acid battery, coupled to the auxiliary load and to the converter, storing energy at the DC voltage; wherein the converter determines a SOC for the lead-acid battery and charges the lead-acid battery to maintain the SOC within a predetermined charge zone, the predetermined charge zone including an upper bound no more than about 90% maximum charge and more preferably no more than about 85% maximum charge and the charge zone having a lower bound no less than about 70% maximum charge and more preferably no less than about 75% maximum charge.

Some advantages of the present invention follow directly from more efficient charging/use of auxiliary batteries. For example, consider the following representative example numbers:

| | |
|---|---|
| Traction Battery Charge Time: | 8 hours |
| Lead-Acid battery waste: | 0.2A × 14 V = 3 watts |
| DC/DC waste: | 25 watts |
| Energy Loss: | 8 hours × 28 watts = 224 watt-hrs/day |
| Customer $ Savings: | $0.13/KWh × 0.224 Watt-hrs × 300 days = |
| | $9 per Year |
| CO2 savings: | 10,000 cars × 0.5 Kg/KWh * 0.224 watt * |
| | hr × 300 days = 336,000 Kg/year |

There will be other systems and methods that operate a lead-acid battery in the partial SOC operation in addition to these described herein. Other features, benefits, and advantages of the present invention will be apparent upon a review of the present disclosure, including the specification, drawings, and claims.

### BRIEF DESCRIPTION OF THE DRAWINGS

FIG. 1 is a block schematic diagram of a portion of an electrical system for an electric vehicle;

FIG. 2 is a process flow diagram for an improved efficiency charging paradigm;

FIG. 3 is a block schematic diagram of a portion of an electrical system 300 for a gasoline-engine powered vehicle 305; and

FIG. 4 is a block schematic diagram of a portion of an electrical system 400 for a load-leveling/backup power assembly 405.

### DETAILED DESCRIPTION OF THE INVENTION

Embodiments of the present invention provide apparatus and method for improving use efficiencies of lead-acid batteries, and more particularly to 12V external lead-acid batteries used in vehicles of all types, load-leveling installations, and backup power applications without suffering risks of sulfation. The following description is presented to enable one of ordinary skill in the art to make and use the invention and is provided in the context of a patent application and its requirements. In the following text, the terms “energy storage system”, “energy storage assembly”, “battery”, “cell”, “brick”, “battery cell”, “battery cell pack”, “pack” “electric double-layer capacitor”, and “ultracapacitor” may be used interchangeably (unless the context indicates otherwise” and may refer to any of a variety of different rechargeable configurations and cell chemistries described herein including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other chargeable high energy storage type/configuration. A context for one implementation is use of rechargeable Li-ion battery packs designed for plug-in electric vehicles (PHEV, HEV, and EV and the like), gasoline/petrochemical engines, load-leveling applications, and backup power supplies.

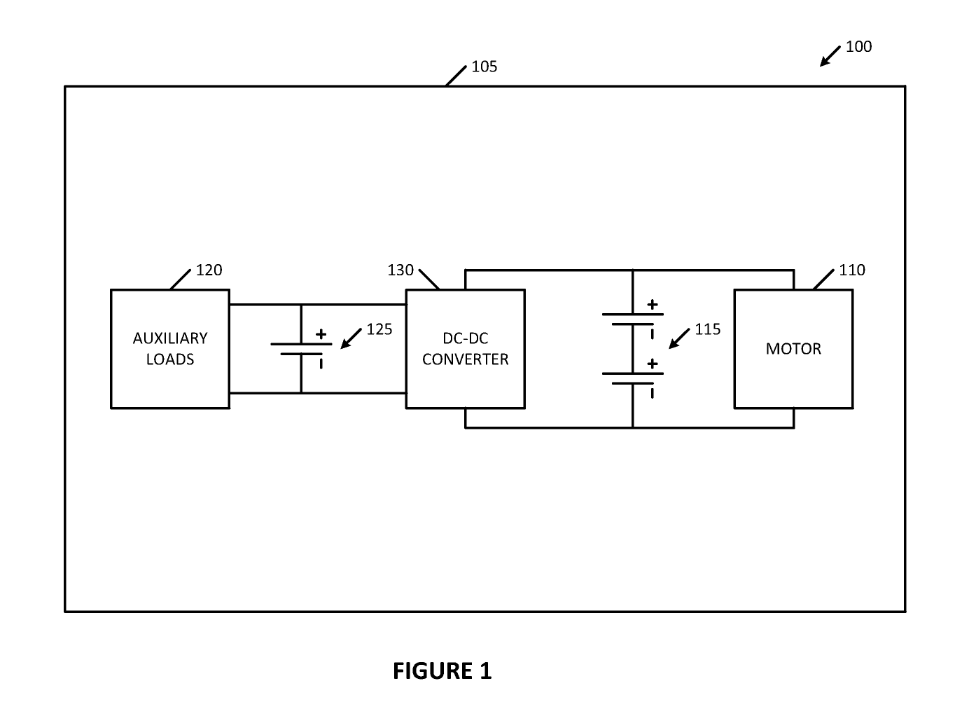

FIG. 1 is a block schematic diagram of a portion of an electrical system 100 for an electric vehicle 105 (as discussed herein, other applications of the present invention are contemplated beyond electric vehicles—however for ease of explanation, the present invention is described in the context of an electric vehicle). EV 105 includes a motor 110, at least partially energized by a traction battery 115. EV 105 also includes a set of auxiliary loads 120 and an auxiliary battery 125. Loads 120 and/or battery 125 are energized from traction battery 115 by use of a DC/DC converter 130.

Traction battery 115 and auxiliary battery 125 are discharged at different rates during operation, with DC/DC converter 130 periodically charging battery 125 and/or energizing auxiliary loads 120. Eventually, EV 105 will be taken to a charging station for a sustained charge to re-energize traction battery 115 to full SOC. Some of the energy available for charging traction battery 115 is used by DC/DC converter 130 to charge auxiliary battery 125.

Note that the present invention is useful in contexts other than electrical systems 100 including a traction battery 115. No matter the mechanism, there is typically an auxiliary battery 125 (nominally 12V lead-acid battery) used in a shallow-discharge application that is subject to charging diagram includes, for purposes of the discussion, an inefficient charging zone in which the SOC of the auxiliary battery is above 85% (other application may use a different parameter for this threshold). The flow diagram described herein addresses improved use efficiency when charging auxiliary battery 125.

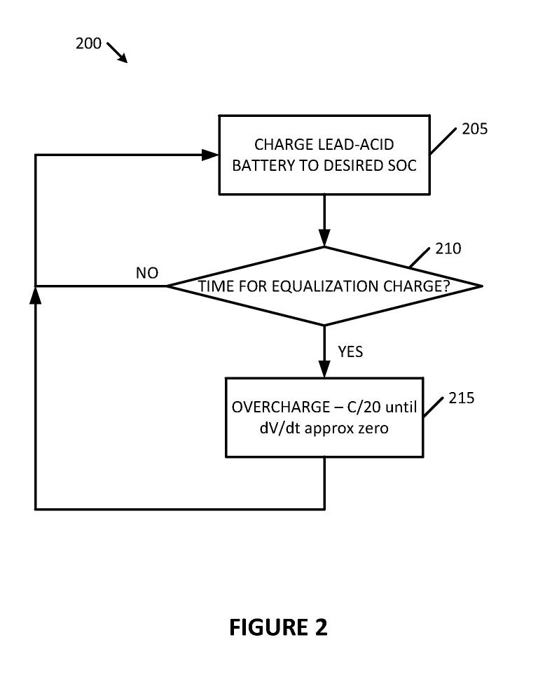

FIG. 2 is a flow diagram for an improved efficiency charging process 200. Process 200 includes a sequence of steps and tests for charging auxiliary battery 125 shown in FIG. 1. Initially, process 200 begins with step 205 to charge the SOC of battery 125 to a desired level. For example, it may be the case that an SOC of a particular lead-acid battery 125 is 0% at 12V and 100% at 13V. The SOC to open open circuit voltage ratio may be assumed to be relatively linear, therefore an open-circuit voltage of about 12.85V would put this battery 125 at about 85% SOC. Voltage regulation of the charger (e.g., DC converter 130) at 12.85V will charge battery 125 to the desired SOC in this particular implementation. In the preferred embodiment of the present invention, the desired SOC may be any value in a range (set an an overcharge point), the range having an upper bound no more than about 90% maximum charge and more preferably no more than about 85% maximum charge and said charge zone having a lower bound no less than about 70% maximum charge and more preferably no less than about 75% maximum charge. One of the reasons the embodiments of the present invention use a selected value in a range is that chemistries of auxiliary batteries differ. Further, overcharge is not always a sharp demarcation, with trade-offs for inefficiency versus SOC. Certain applications may tolerate more or less inefficiency, which, along with battery chemistry, will set the overcharge point (and thus the desired SOC).

There are several well-known ways to determine the SOC of battery 125, any of which could be used to establish the SOC. In some cases, step 205 includes determining the SOC of the battery, determining if the battery is in a charge/no-charge zone, and managing a charger consistent with this determination. Such an “SOC determiner” may be part of the DC/DC converter, an alternator, converter, or other element of the system (or in some cases a stand-alone element).

Process 200 periodically applies an equalization charge to reduce/eliminate the effects of sulfation of auxiliary battery 125. In the preferred embodiment, the periodicity of the equalization charge is about one time every week, but other applications may include different periods. (This is reflected in process 200 by test 210 following step 205.)

When it is time to apply the equalization charge, process 200 advances to step 215 from the test at step 210 to overcharge auxiliary battery 125 which removes crystals that have likely formed by not fully charging auxiliary battery 125 during step 205. In the preferred embodiment, the equalization is an overcharge of about C/20 (where C is the charge rate and represents a current rate equal to a capacity of a battery in one hour) until a change of voltage over time (dv/dt) is about equal to zero. Some batteries and applications may use a different equalization charge. Again, a goal of this step 215 is to counter, to the desired/necessary degree, any sulfation-related deterioration of auxiliary battery 125. After step 215, or when the test at step 210 is negative, process 200 returns to step 205 to continue to charge to the desired SOC.

The apparatus and methods above have been described in the preferred embodiment of a charger that improves certain identified inefficiencies charging lead-acid batteries used in electric vehicles. As noted above, embodiments of the present invention are useful in other contexts, methods, and apparatus. By using the embodiments of the present invention disclosed herein, the present invention may be applied to load-leveling and backup power systems, in addition to other vehicles such as gasoline or hybrid vehicles. For example, in a vehicle powered exclusively by a gasoline engine, there is no traction battery 115 and likely no DC/DC converter 130. However, the auxiliary loads 120 and auxiliary battery 125 still exist, but are energized by an alternator rather than DC/DC converter 130.

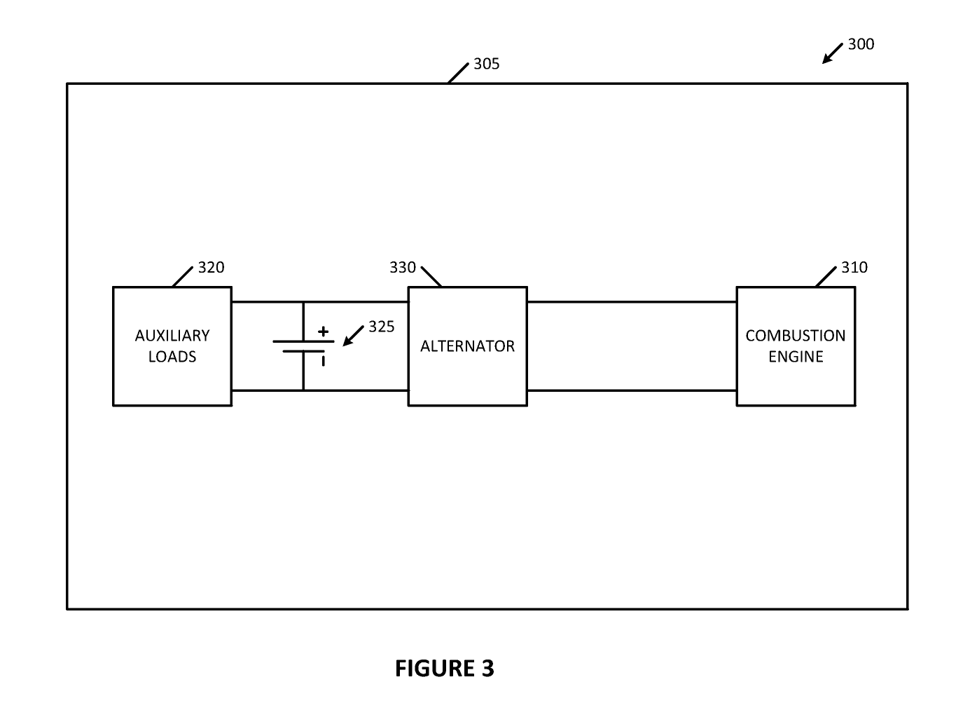

FIG. 3 is a block schematic diagram of a portion of an electrical system 300 for a gasoline vehicle 305. Vehicle 305 includes a combustion engine 310. Vehicle 305 also includes a set of auxiliary loads 320 and an auxiliary battery 325. Loads 320 and/or battery 325 are energized from engine 310 by use of an alternator 330. Alternator 330 is typically operated from a mechanical coupling to an output power of engine 310. Note that, in some implementations, it would be possible to drive an alternator from a mechanical coupling to an electric motor as well.

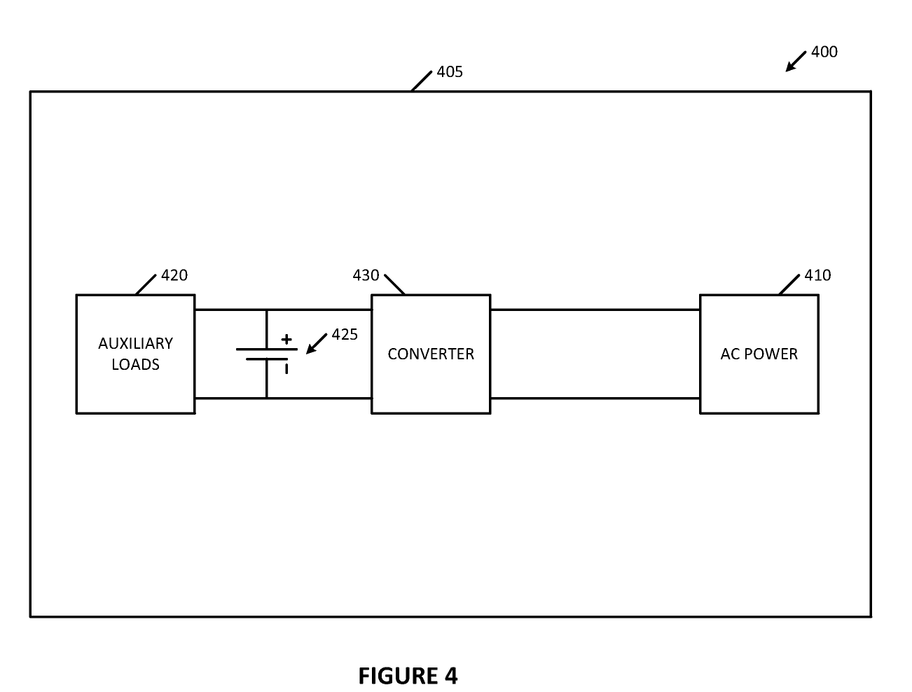

FIG. 4 is a block schematic diagram of a portion of an electrical system 400 for a load-leveling/backup power assembly 405. Assembly 405 includes an AC source (e.g., grid power or the like) 410. Assembly 405 also includes a set of auxiliary loads 420 and an auxiliary battery 425. Loads 420 and/or battery 425 are energized from AC source 420 by use of a converter 430.

Note that in the discussion of the DC/DC converter, alternator, and AC/DC converter, there is a certain degree of computation and process execution described (e.g., determining an SOC and/or determining whether to apply the equalization charge and the like) which may be a function integrated into the device, a stand-alone controller, or part of another control system used in the application. For ease of explanation, that function is described as part of the device but need not be part of the device for some applications/implementations.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A method, the method comprising the steps of:
a) determining a state of charge (SOC) for a lead-acid battery;
b) comparing said SOC against a predetermined charge zone, said charge zone having an upper bound no more than about 90% maximum charge and more preferably no more than about 85% maximum charge and said charge zone having a lower bound no less than about 70% maximum charge and more preferably no less than about 75% maximum charge; and
c) maintaining a charge of said lead-acid battery wherein said SOC is within said charge zone.

2. The method of claim 1 further comprising the step of:
d) overcharging periodically said lead-acid battery at about C/20 until dv/dt is about equal to zero.

3. The method of claim 2 wherein said overcharging step d) has a period about equal to one week.

4. The method of claim 1 wherein said lead-acid battery is used in an assembly selected from one or more elements from the group consisting of an electric vehicle, a hybrid vehicle, a gasoline vehicle, a backup power system, a load-leveling application, and combinations thereof.

5. An apparatus, comprising:
an SOC-determiner establishing an SOC for a lead-acid battery, said determiner producing an SOC signal indicating said SOC;
a charger, coupled to said lead-acid battery and responsive to said SOC signal, to maintain said SOC for said lead-acid battery within a predetermined charge zone, said predetermined charge zone having an upper bound no more than about 90% maximum charge and more preferably no more than about 85% maximum charge and said charge zone having a lower bound no less than about 70% maximum charge and more preferably no less than about 75% maximum charge.

6. The apparatus of claim 5 wherein said charger periodically overcharges said lead-acid battery at about C/20 until dv/dt is about equal to zero.

7. The apparatus of claim 6 wherein said overcharging has a period about equal to one week.

8. The apparatus of claim 5 wherein said lead-acid battery is used in an assembly selected from one or more elements from the group consisting of an electric vehicle, a hybrid vehicle, a gasoline vehicle, a backup power system, a load-leveling application, and combinations thereof.

9. A system, comprising:
a motor powered at least in part by energy provided from an internal combustion of a fuel with an oxidizer that applies a direct force to a mechanical component;
an auxiliary load operable at least in part by energy provided at a DC voltage;
an alternator, coupled to said mechanical component, for converting a portion of said direct force to said DC voltage; and
a lead-acid battery, coupled to said auxiliary load and to said alternator, storing energy at said DC voltage;
wherein said alternator determines a SOC for said lead-acid battery and charges said lead-acid battery to maintain said SOC within a predetermined charge zone, said predetermined charge zone including an upper bound no more than about 90% maximum charge and more preferably no more than about 85% maximum charge and said charge zone having a lower bound no less than about 70% maximum charge and more preferably no less than about 75% maximum charge.

10. The system of claim 9 wherein said alternator periodically overcharges said lead-acid battery at about C/20 until dv/dt is about equal to zero.

11. A system, comprising:
an electric power storage system operating at a first DC voltage;
a motor, coupled to said electric power storage system, powered at least in part by energy provided from said storage system at said first DC voltage;
an auxiliary load operable at least in part by energy provided at a second DC voltage;
a DC/DC converter, coupled to said electric power storage system, for converting said first DC voltage to said second DC voltage; and
a lead-acid battery, coupled to said auxiliary load and to said DC/DC converter, storing energy at said second DC voltage;
wherein said DC/DC converter determines a SOC for said lead-acid battery and charges said lead-acid battery to maintain said SOC within a predetermined charge zone, said predetermined charge zone including an upper bound no more than about 90% maximum charge and more preferably no more than about 85% maximum charge and said charge zone having a lower bound no less than about 70% maximum charge and more preferably no less than about 75% maximum charge.

12. The system of claim 11 wherein said DC/DC converter periodically overcharges said lead-acid battery at about C/20 until dv/dt is about equal to zero.

13. A system, comprising:
an AC power source powered at least in part by energy provided from an electrical grid;
an auxiliary load operable at least in part by energy provided at a DC voltage;
a converter, coupled to said AC power source, for converting a portion of said AC power to said DC voltage; and
a lead-acid battery, coupled to said auxiliary load and to said converter, storing energy at said DC voltage;
wherein said converter determines a SOC for said lead-acid battery and charges said lead-acid battery to maintain said SOC within a predetermined charge zone, said predetermined charge zone including an upper bound no more than about 90% maximum charge and more preferably no more than about 85% maximum charge and said charge zone having a lower bound no less than about 70% maximum charge and more preferably no less than about 75% maximum charge.

14. The system of claim 13 wherein said alternator periodically overcharges said lead-acid battery at about C/20 until dv/dt is about equal to zero.

15. A method for charging an lead-acid battery, the method comprising the steps of:
a) regulating a charging voltage applied to the lead-acid battery to produce a state-of-charge (SOC) for the lead-acid battery at a point less than about an overcharge SOC of the lead-acid battery;
b) charging the lead-acid battery with said charging voltage; and
c) maintaining said SOC of the lead-acid battery less than said overcharge SOC.

16. The method of claim 15 further comprising the step of:
d) overcharging periodically said lead-acid battery at about C/20 until dv/dt is about equal to zero.

17. An apparatus for charging a lead-acid battery, comprising:
a regulator establishing an SOC for a lead-acid battery, said regulator establishing a desired SOC for the lead-acid battery;
a charger, coupled to the lead-acid battery and responsive to said desired SOC, to maintain said SOC for said lead-acid battery within a predetermined charge zone, said predetermined charge zone having an upper bound no more than about 90% maximum charge and more preferably no more than about 85% maximum charge and said charge zone having a lower bound no less than about 70% maximum charge and more preferably no less than about 75% maximum charge.

18. The apparatus of claim 17 wherein said charger periodically overcharges said lead-acid battery at about C/20 until dv/dt is about equal to zero.

19. The apparatus of claim 18 wherein said overcharging has a period about equal to one week.
